(19) United States
(12) Patent Application Publication
(10) Pub. No.: US 2016/0154676 A1
(43) Pub. Date: Jun. 2, 2016

(54) Method of Resource Allocation in a Server System

(71) Applicants: Inventec (Pudong) Technology Corp., Shanghai (CN); Inventec Corporation, Taipei (TW)

(72) Inventors: Hung-Pin Wen, Taipei (TW); Wei-Chu Lin, Taipei (TW); Gen-Hen Liu, Taipei (TW); Kuan-Tsen Kuo, Taipei (TW); Kuo-Feng Huang, Taipei (TW); Dean-Chung Wang, Taipei (TW)

(21) Appl. No.: 14/672,252

(22) Filed: Mar. 30, 2015

(30) Foreign Application Priority Data
Nov. 28, 2014 (CN) 201410707966.9

(51) Int. Cl. G06F 9/50; G06N 3/02; G06F 9/455

(52) U.S. Cl. CPC G06F 9/50; G06F 9/45533; G06N 3/02

(57) ABSTRACT

A method of resource allocation in a server system includes predicting a resource requirement of an application by adopting a neural network algorithm. When the resource requirement of the application is greater than a virtual machine allocation threshold, turn on a virtual machine for the application and adjust the value of the virtual machine allocation threshold to be the sum of the virtual machine allocation threshold and a resource capacity of the virtual machine.

### BACKGROUND OF THE INVENTION

1. Field of the Invention

The present invention relates to a method of resource allocation in a server system, and more particularly, to a method of resource allocation that is application-aware.

2. Description of the Prior Art

As the development of the internet and cloud computing rises prosperously, the management and the usage of network resources have also become more and more complicated. The datacenter begins to adopt the concept of virtual machine to improve the efficiency of the resource allocation. The server system in the datacenter may include a plurality of virtual machines, and the virtual machines in the server system can be physicalized only when needed. Consequently, the hardware resources of the same server can be used to perform applications on different operation systems and the flexibility of the hardware resources can be improved.

The previous method of resource allocation in the server system may determine whether to add more resources or not by considering the loading of the server. However, since the server system is not aware of what kinds of applications are processed by the virtual machines, the system server may have to add additional resources to ensure that all the applications can meet the requirements of the service level agreement (SLA) between the server system provider and the customer. For example, to ensure the service can be completed within a response time, the server system may have to allocate additional hardware resources for the users, which may cause a waste of the hardware. Furthermore, when the resources required by the application are reduced, parts of the resources may become idle. If the idle hardware resources cannot be released to other applications or other customers instantly, the server system may encounter the issue of hardware resource shortage. Since the amount of resource requirements for the applications performing on the cloud computing datacenter can vary drastically, how to allocate the resources efficiently has become a critical issue.

### SUMMARY OF THE INVENTION

One embodiment of the present invention discloses a method of resource allocation in a server system. The method comprises predicting a resource requirement of an application by adopting a neural network algorithm, when the resource requirement of the application is greater than a virtual machine allocation threshold, turning on a virtual machine for the application, and adjusting the value of the virtual machine allocation threshold to be a sum of the virtual machine allocation threshold and a resource capacity of the virtual machine.

Another embodiment of the present invention discloses a method of resource allocation in a server system. The method comprises predicting a resource requirement of an application by adopting a neural network algorithm, when the resource requirement of the application is smaller than a difference between a virtual machine allocation threshold and a resource capacity of a virtual machine, turning off the virtual machine in the server system, and adjusting the value of the virtual machine allocation threshold to be the virtual machine allocation threshold minus the resource capacity of the virtual machine.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a server system according to one embodiment of the present invention.

FIG. 2 shows a flow chart of a method of resource allocation in the server system in FIG. 1 according to one embodiment of the present invention.

FIG. 3 shows a flow chart of a method of resource allocation in the server system in FIG. 1 according to another embodiment of the present invention.

FIG. 4 shows a flow chart of a method of resource allocation in the server system in FIG. 1 according to another embodiment of the present invention.

FIG. 5 shows a flow chart of a method of resource allocation in the server system in FIG. 1 according to another embodiment of the present invention.

### DETAILED DESCRIPTION

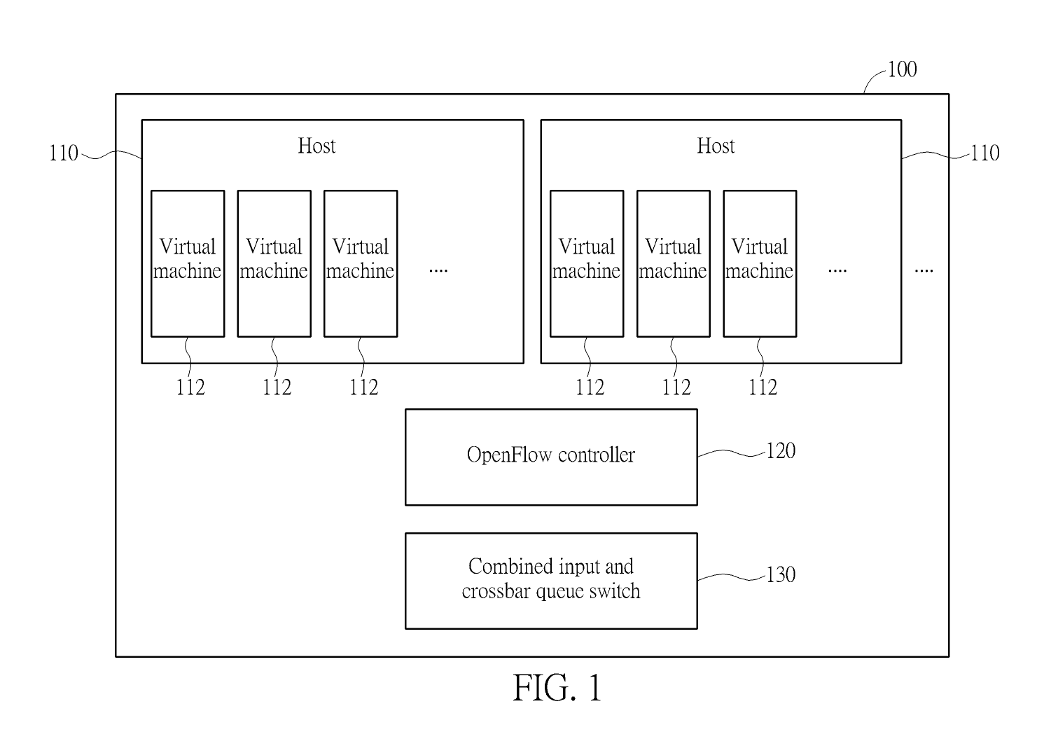

FIG. 1 shows a server system 100 according to one embodiment of the present invention. The server system 100 comprises at least one host 110 and each host 110 can provide at least one virtual machine 112. In some embodiments of the present invention, the server system 100 can include an OpenFlow controller 120 and a combined input and crossbar queue (CICQ) switch 130. The OpenFlow controller 120 can be configured to implement a network layer of the server system 100 based on a software-defined network (SDN) to transfer a plurality of packages. The CICQ switch 130 can be configured to schedule the plurality of packages. In some embodiments of the present invention, each of the plurality of packages transferred by the OpenFlow controller 120 may comprise an application header so that the OpenFlow controller 120 can identify the corresponding application of each of the packages.

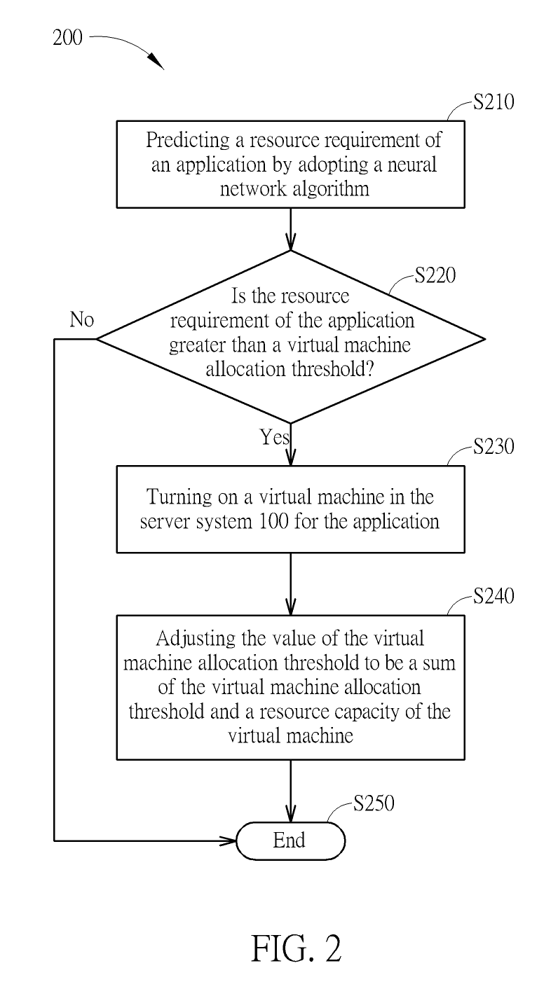

FIG. 2 shows a flow chart of a method 200 of resource allocation in the server system 100. In one embodiment of the present invention, the server system 100 can be used to perform different applications, ex., searching engine, 3D gaming, social network, video transmission, e-mail, and etc., and the server system 100 can allocate the system resource according to the characteristics of resource requirement of each application. The method 200 comprises steps S210-S250 as below:

S210: predicting a resource requirement of an application by adopting a neural network algorithm;

S220: when the resource requirement of the application is greater than a virtual machine allocation threshold, going to step S230; otherwise, going to step S250;

S230: turning on a virtual machine in the server system 100 for the application;

S240: adjusting the value of the virtual machine allocation threshold to be a sum of the virtual machine allocation threshold and a resource capacity of the virtual machine;

S250: end.

In step S210, the server system 100 can adopt the neural network algorithm to predict the resource requirement of each of the applications and can take a resource requirement of central processing units (CPUs) of the application, a resource requirement of memories, a resource requirement of graphic processing units (GPUs), a resource requirement of hard disk input/output (I/O), and a resource requirement of network bandwidths as input parameters of the neural network algorithm. In addition, since the user may tend to use different applications at different times, a time stamp may also be taken as an input parameter of the neural network algorithm in some embodiments of the present invention.

In step S220, the server system 100 can check if the resource requirement of each of the applications is greater than the virtual machine allocation threshold. When the resource requirement of the application is greater than the virtual machine allocation threshold, the present activated hardware resource may not be enough to perform the application. Therefore, in step S230, a new virtual machine is turned on for the application, that is, the virtual machine is physicalized in the server system 100 and the physicalized virtual machine can only be used to perform the corresponding application. In some embodiments of the present invention, each of the virtual machines can have the same amount of resource capacity so after the new virtual machine is turned on, the value of the virtual machine allocation threshold can be adjusted to be the sum of the virtual machine allocation threshold and the resource capacity of the virtual machine in step S240. Consequently, the virtual machine allocation threshold of the applications can be used to show the resource of the virtual machines currently allocated to the application has been increased by the resource capacity of a virtual machine.

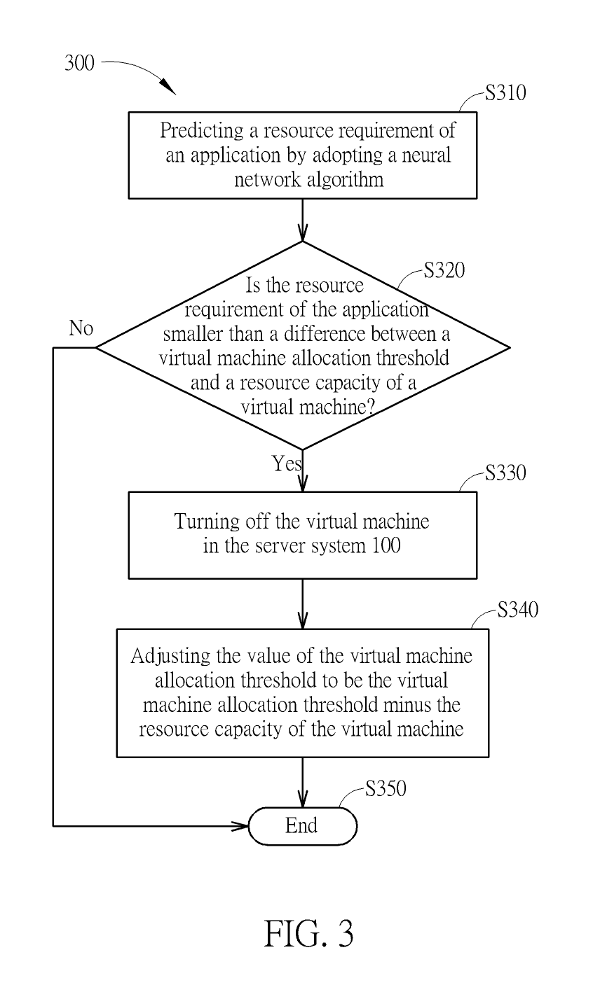

FIG. 3 shows a flow chart of a method 300 of resource allocation in the server system 100. The method 300 comprises steps S310-S350 as below:

S310: predicting a resource requirement of an application by adopting a neural network algorithm;

S320: when the resource requirement of the application is smaller than a difference between a virtual machine allocation threshold and a resource capacity of a virtual machine, going to step S330; otherwise, going to step S350;

S330: turning off the virtual machine in the server system 100;

S340: adjusting the value of the virtual machine allocation threshold to be the virtual machine allocation threshold minus the resource capacity of the virtual machine;

S350: end.

After predicting the resource requirement of the application in step S310, step S320 may check if the resource requirement of the application is smaller than the difference between the virtual machine allocation threshold and the resource capacity of a virtual machine. When the resource requirement of the application is smaller than the difference between the virtual machine allocation threshold and the resource capacity of a virtual machine, the present activated hardware resource may already be enough to perform the application even by turning off a virtual machine from the currently physicalized machines. Therefore, in step S330, a virtual machined used by the application can be turned off in the server system 100 so the resource of the virtual machine can be released to other applications and the power consumption of the server system 100 can be reduced. Furthermore, in step S340, the value of the virtual machine allocation threshold can be adjusted to be the virtual machine allocation threshold minus the resource capacity of the virtual machine so the virtual machine allocation threshold of the applications can still be used to show the resource of the virtual machines currently allocated to the application.

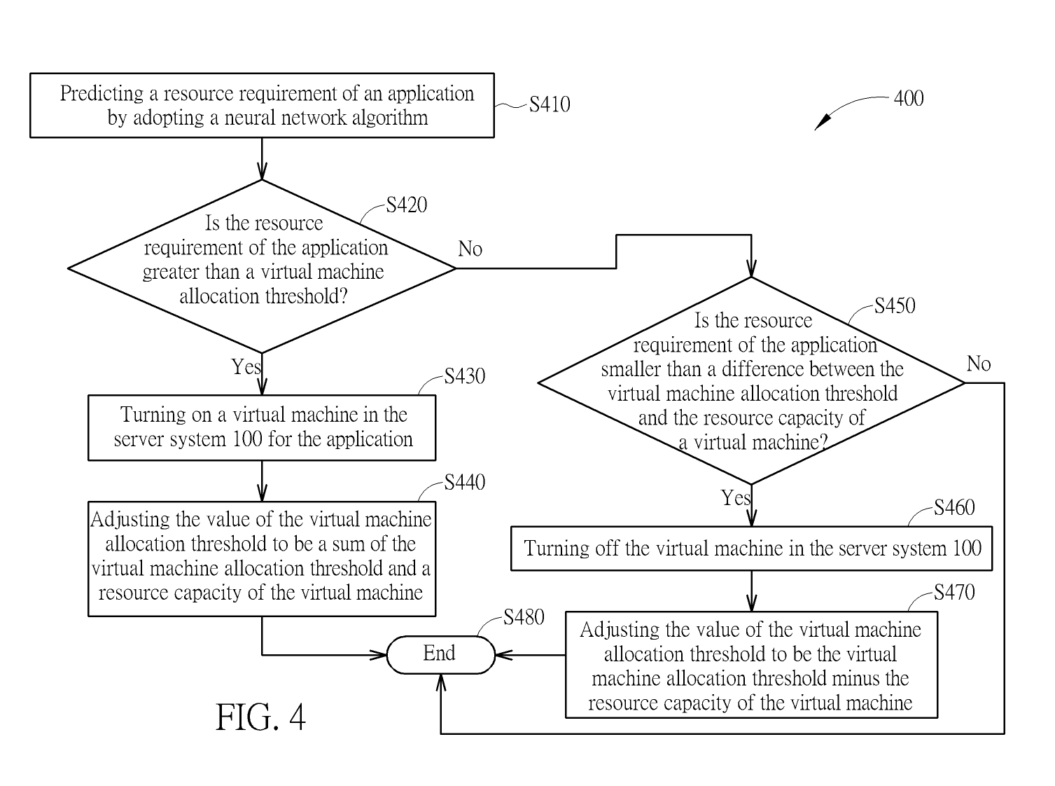

In addition, the methods 200 and 300 can both applied to the server system 100 to allocate the hardware resource. FIG. 4 shows a flow chart of a method 400 of resource allocation in the server system 100. The method 400 comprises steps S410-S480 as below:

S410: predicting a resource requirement of an application by adopting a neural network algorithm;

S420: when the resource requirement of the application is greater than a virtual machine allocation threshold, going to step S430; otherwise, going to step S450;

S430: turning on a virtual machine in the server system 100 for the application;

S440: adjusting the value of the virtual machine allocation threshold to be a sum of the virtual machine allocation threshold and a resource capacity of the virtual machine; going to step S480;

S450: when the resource requirement of the application is smaller than a difference between the virtual machine allocation threshold and the resource capacity of a virtual machine, going to step S460; otherwise, going to step S480;

S460: turning off the virtual machine in the server system 100;

S470: adjusting the value of the virtual machine allocation threshold to be the virtual machine allocation threshold minus the resource capacity of the virtual machine;

S480: end.

The method 400 includes the determining conditions in the methods 200 and 300, and the method 400 can be operated in the similar operating principles as the methods 200 and 300. Although in FIG. 4, step S450 is performed after step S420, the present invention is not limited to this order. In other embodiments of the present invention, the determining condition in step S450 can be checked firstly, namely, if the resource requirement of the application is smaller than the difference between the virtual machine allocation threshold and the resource capacity of the virtual machine, steps S460 and S470 will be performed; otherwise, the determining condition in step S420 can be checked and see if steps S430 and S440 are to be processed or not.

According to the methods of resource allocation 200, 300 and 400, the server system 100 can allocate the hardware resource by predicting the resource requirement of the application, turn on the virtual machine only when the application needs it, and turn off the virtual machine when the application does not need it. Therefore, the resource allocation of the server system 100 can be more efficient and flexible, and the power consumption of the server system 100 can be reduced.

In addition, to ensure the quality of the service, the service level agreement (SLA) is often set between the server system provider and the customer. A common SLA may include a condition that the server system must complete the service requested by the customer within a response time. In order to meet the SLA when the server system 100 allocates the hardware resource, the server system 100 can adjust the possibility of turning on a virtual machine or turning off a virtual machine according to the execution time of the application.

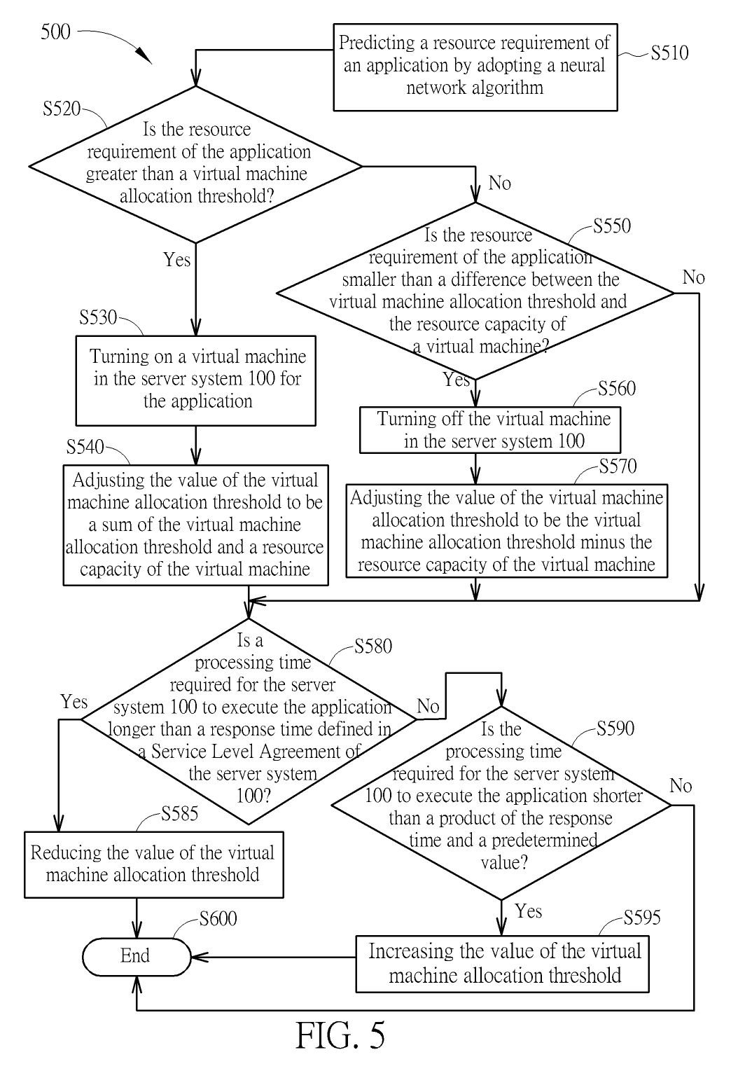

FIG. 5 shows a flow chart of a method 500 of resource allocation in the server system 500. The method 500 comprises steps S510-S600 as below:

S510: predicting a resource requirement of an application by adopting a neural network algorithm;

S520: when the resource requirement of the application is greater than a virtual machine allocation threshold, going to step S530; otherwise, going to step S550;

S530: turning on a virtual machine in the server system 100 for the application;

S540: adjusting the value of the virtual machine allocation threshold to be a sum of the virtual machine allocation threshold and a resource capacity of the virtual machine; going to step S580;

S550: when the resource requirement of the application is smaller than a difference between the virtual machine allocation threshold and the resource capacity of a virtual machine, going to step S560; otherwise, going to step S580;

S560: turning off the virtual machine in the server system 100;

S570: adjusting the value of the virtual machine allocation threshold to be the virtual machine allocation threshold minus the resource capacity of the virtual machine;

S580: when a processing time required for the server system 100 to execute the application is longer than a response time defined in a Service Level Agreement of the server system 100, going to step S585; otherwise, going to step S590;

S585: reducing the value of the virtual machine allocation threshold and going to step S600;

S590: when the processing time required for the server system 100 to execute the application is shorter than a product of the response time and a predetermined value, going to step S595; otherwise, going to step S600;

S595: increasing the value of the virtual machine allocation threshold;

S600: end.

Steps S510-S570 are following the similar operating principles as steps S410-S470. In Step S580, when the processing time required for the server system 100 to execute the application is longer than the response time defined in the SLA of the server system 100, the server system 100 may require more hardware resource to meet the response time defined in the SLA. In this case, step S585 can reduce the value of the virtual machine allocation threshold so the next time when the server system 100 determines whether to turn on a new virtual machine for the application, the possibility of turning on a new virtual machine to meet the requirement of response time is increased due to the reduction of the value of the virtual machine allocation threshold. In some embodiments of the present invention, step S585 can adjust the virtual machine allocation threshold to be a product of the virtual machine allocation threshold and a weighting of the SLA, and the weighting of the SLA is between 0 and 1. If the server system 100 needs to follow the SLA strictly, the weighting of the SLA can be closer to 0 so that the value of the virtual machine allocation threshold can be reduced faster. Contrarily, if the SLA allows more violations, the weighting of the SLA can be closer to 1 so that the value of the virtual machine allocation threshold can be reduced slower, the condition for turning on a virtual machine will be rather difficult to reach, and the waste of hardware resource can be reduced.

In step S590, the predetermined value can be smaller than 1 so that when the processing time required for the server system to execute the application is shorter than the product of the response time and the predetermined value, the present hardware resource activated for the application may already be enough to meet the response time defined in the SLA. In this case, step S595 can increase the value of the virtual machine allocation threshold; therefore, the next time when the server system 100 determines whether to turn off a virtual machine, the possibility of turning off the virtual machine to avoid unnecessary waste of hardware resource is increased due to the increase of the value of the virtual machine allocation threshold. In some embodiments of the present invention, the predetermined value can be 0.5. In some other embodiments of the present invention, the predetermined value can be adjusted according to how strict the SLA is. If the SLA needs to be followed strictly, the predetermined value can be adjusted to be smaller, ex., 0.4. Contrarily, if the SLA allows more violations, the predetermined value can be greater, ex., 0.75. In step S595, the value of the virtual machine allocation threshold can be adjusted to be the product of the value of the virtual machine allocation threshold and a weighting of power consumption, and the weighting of power consumption is between 1 and 2. If the server system 100 needs to follow SLA strictly, the weighting of power consumption can be adjusted to be closer to 1 so that the value of the virtual machine allocation threshold can be increased slower and the condition to turning off the virtual machine can be rather difficult to meet. Contrarily, the weighting of power consumption can be closer to 2 so that the value of the virtual machine allocation threshold can be increased faster and the condition to turning off the virtual machine can be easier to meet, which can prevent the waste of hardware resource and reduce the power consumption more aggressively.

Furthermore, although in FIG. 5, step S590 is performed after step S580, the present invention is not limited to this order. In other embodiments of the present invention, the condition in step S590 can be checked firstly, namely, if the processing time required for the server system 100 to execute the application is shorter than the product of the response time and the predetermined value, step S595 will be performed; otherwise, the condition in step S580 can be checked and see if step S585 is to be processed or not.

According to the method of resource allocation 500, the server system 100 can allocate the hardware resource by predicting the resource requirement of the application and considering the requirements of the SLA. Thus, while the requirements in the SLA can be fulfilled, the server system 100 can turn on the virtual machine only when the application needs it, and turn off the virtual machine when the application does not need it. Therefore, the resource allocation of the server system 100 can be more efficient and flexible, and the power consumption of the server system 100 can be reduced.

In summary, according to the method of resource allocation in the server system provided by the embodiments of the present invention, the server system is able to allocate the hardware resource by predicting the resource requirement of the application and considering the requirements of the SLA. Thus, while the requirements in the SLA can be fulfilled, the server system can turn on the virtual machine only when the application needs it, and turn off the virtual machine when the application does not need it. Therefore, the resource allocation of the server system can be more efficient and flexible, and the power consumption of the server system can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of resource allocation in a server system, comprising:
predicting a resource requirement of an application by adopting a neural network algorithm;
when the resource requirement of the application is greater than a virtual machine allocation threshold:
turning on a virtual machine for the application; and
adjusting the value of the virtual machine allocation threshold to be a sum of the virtual machine allocation threshold and a resource capacity of the virtual machine.

2. The method of claim 1, further comprising:
when a processing time required for the server system to execute the application is longer than a response time defined in a Service Level Agreement (SLA) of the server system, reducing the value of the virtual machine allocation threshold.

3. The method of claim 2, wherein reducing the value of the virtual machine allocation threshold is adjusting the virtual machine allocation threshold to be a product of the virtual machine allocation threshold and a weighting of the SLA, and the weighting of the SLA is between 0 and 1.

4. The method of claim 1, further comprising:
when a processing time required for the server system to execute the application is shorter than a product of the response time and a predetermined value, increasing the value of the virtual machine allocation threshold.

5. The method of claim 4, wherein the predetermined value is 0.5.

6. The method of claim 4, wherein increasing the value of the virtual machine allocation threshold is adjusting the value of the virtual machine allocation threshold to be a product of the value of the virtual machine allocation threshold and a weighting of power consumption, and the weighting of power consumption is between 1 and 2.

7. The method of claim 1, wherein predicting the resource requirement of the application by adopting the neural network algorithm is taking a resource requirement of central processing units of the application, a resource requirement of memories, a resource requirement of graphic processing units, a resource requirement of hard disk input/output, a resource requirement of network bandwidths and a time stamp as input parameters of the neural network algorithm.

8. The method of claim 1, wherein the server system comprises:
an OpenFlow controller configured to implement a network layer of the server system based on a software-defined network to transfer a plurality of packages; and
a combined input and crossbar queue switch configured to schedule the plurality of packages.

9. The method of claim 8, wherein each of the plurality of packages transferred by the OpenFlow controller comprises an application header to indicate a corresponding application of the package.

10. A method of resource allocation in a server system, comprising:
predicting a resource requirement of an application by adopting a neural network algorithm;
when the resource requirement of the application is smaller than a difference between a virtual machine allocation threshold and a resource capacity of a virtual machine:
turning off the virtual machine in the server system; and
adjusting the value of the virtual machine allocation threshold to be the virtual machine allocation threshold minus the resource capacity of the virtual machine.

11. The method of claim 10, further comprising:
when a processing time required for the server system to execute the application is longer than a response time defined in a Service Level Agreement (SLA) of the server system, reducing the value of the virtual machine allocation threshold.

12. The method of claim 11, wherein reducing the value of the virtual machine allocation threshold is adjusting the virtual machine allocation threshold to be a product of the virtual machine allocation threshold and a weighting of the SLA, and the weighting of the SLA is between 0 and 1.

13. The method of claim 10, further comprising:
when a processing time required for the server system to execute the application is shorter than a product of the response time and a predetermined value, increasing the value of the virtual machine allocation threshold.

14. The method of claim 13, wherein the predetermined value is 0.5.

15. The method of claim 13, wherein increasing the value of the virtual machine allocation threshold is adjusting the value of the virtual machine allocation threshold to be a product of the value of the virtual machine allocation threshold and a weighting of power consumption, and the weighting of power consumption is between 1 and 2.

16. The method of claim 10, wherein predicting the resource requirement of the application by adopting the neural network algorithm is taking a resource requirement of central processing units of the application, a resource requirement of memories, a resource requirement of graphic processing units, a resource requirement of hard disk input/output, a resource requirement of network bandwidths and a time stamp as input parameters of the neural network algorithm.

17. The method of claim 10, wherein the server system comprises:
an OpenFlow controller configured to implement a network layer of the server system based on a software-defined network to transfer a plurality of packages; and
a combined input and crossbar queue switch configured to schedule the plurality of packages.

18. The method of claim 17, wherein each of the plurality of packages transferred by the OpenFlow controller comprises an application header to indicate a corresponding application of the package.
